(19) United States
(12) Patent Application Publication
(10) Pub. No.: US 2011/0095992 A1
(43) Pub. Date: Apr. 28, 2011

(54) TOOLS WITH MULTIPLE CONTACT POINTS FOR USE ON TOUCH PANEL

(75) Inventor: Yuan Shuen Yeh, Taibao City (TW)

(73) Assignee: ATEN International Co., Ltd., Taipei (TW)

(21) Appl. No.: 12/605,510

(22) Filed: Oct. 26, 2009

(51) Int. Cl. G06F 3/041

(52) U.S. Cl. 345/173

(57) ABSTRACT

A tool used for interacting with a touch screen system is described. The tool is an object having multiple contact points that can contact the touch screen at multiple contact points simultaneously. The touch screen system detects the positions of the multiple contact points and matches a geometric pattern formed by the multiple contact points with pre-stored geometric patterns to recognize a virtual device. The touch screen system then performs appropriate functions defined for the recognized virtual device. An MCP (multiple contact point) mouse, an MCP fingertip, and an MCP key tool are described along with their use.

### BACKGROUND OF THE INVENTION

1. Field of the Invention

This invention relates to a pointing device for touch panels, and in particular, it relates to a pointing device having multiple contact points in contact with the touch panel when performing pointing functions.

2. Description of the Related Art

Touch sensitive screens (also referred to as touch panels, touch screens, etc.) are widely used for displaying information and for users to interact with electronic devices. Typically, a user interacts with the touch screen by touching the screen with a stylus or one or more fingers, including briefly touching the screen (“clicking”), moving the stylus or fingers across the screen, etc. Touch screen devices include those having relatively small screens, such as bank ATM machines, personal electronic devices such as personal digital assistants (PDAs) and cellular phones, tablet computers, etc. Large format touch screens, often many feet in sizes, are gaining increased use and are seen as large display screens used in public places, wall-sized display screens in TV newsrooms, etc.

### SUMMARY OF THE INVENTION

The present invention is directed to tools for use with touch screens that substantially obviates one or more of the problems due to limitations and disadvantages of the related art.

An object of the present invention is to provide pointing devices for touch screens, in particular large format touch screens.

Another object of the present invention is to provide pointing devices for large format touch screens with security features.

Additional features and advantages of the invention will be set forth in the descriptions that follow and in part will be apparent from the description, or may be learned by practice of the invention. The objectives and other advantages of the invention will be realized and attained by the structure particularly pointed out in the written description and claims thereof as well as the appended drawings.

To achieve these and other advantages and in accordance with the purpose of the present invention, as embodied and broadly described, the present invention provides a touch screen system, which includes: a touch screen for detecting simultaneous touches at a plurality of contact points on the touch screen, the plurality of contact points or a subset thereof forming a geometric pattern; and a control section connected to the touch sensitive screen, the control section storing a plurality of pre-stored geometric patterns each corresponding to one of a plurality of virtual devices, the control section matches the geometric pattern formed by the plurality of contact points with the pre-stored geometric patterns to recognize one of the plurality of virtual devices. The control section may further perform one or more functions corresponding to the recognized virtual device. The plurality of virtual devices includes a virtual mouse, a virtual fingertip, and a virtual key frame.

In another aspect, the present invention provides a mouse tool for use with a touch screen, which includes: a body; a first plurality of protruding contact points disposed on a bottom side of the body, the first plurality of contact points having lower ends disposed on a plane forming a geometric pattern; a button mechanically coupled to the body; and a moveable protruding contact point mechanically coupled to the button or disposed on a bottom side of the button, wherein when the button is pressed down, the moveable protruding contact point moves down and a lower end of the moveable protruding contact point is located on the plane formed by the lower ends of the first plurality of protruding contact points.

In another aspect, the present invention provides a fingertip tool for use with a touch screen, which includes: a cover having an inner dimension (e.g. inner diameter) of 1 cm to 2 cm; and a plurality of contact points disposed near one end of the cover forming a geometric pattern.

In another aspect, the present invention provides a key tool for use with a touch screen, which includes: a key frame object having a first plurality of contact points disposed on a bottom side of the key frame object forming a first geometric pattern in a plane; and a key object having a second plurality of contact points disposed on a bottom side of the key object forming a second geometric pattern in a plane, wherein the key frame object and the key object have matching shapes.

In another aspect, the present invention provides a method of interacting with a system including a touch screen and a control section connected to the touch screen, which includes: placing a tool on the touch screen, wherein the tool has a plurality of contact points that simultaneously contact the touch screen, the plurality of contact points or a subset thereof forming a geometric pattern; the touch screen detecting the positions of the first plurality of contact points; the control section storing a plurality of pre-stored geometric patterns each corresponding to one of a plurality of virtual devices, and the control section matching the geometric pattern formed by the plurality of contact points with the pre-stored geometric patterns to recognize one of the plurality of virtual devices.

It is to be understood that both the foregoing general description and the following detailed description are exemplary and explanatory and are intended to provide further explanation of the invention as claimed.

### BRIEF DESCRIPTION OF THE DRAWINGS

FIG. 1a-1f illustrate a multiple contact point (MCP) mouse tool according to a first embodiment of the present invention.

FIG. 2 schematically illustrates the positions of a plurality of contact points of the MCP mouse.

FIG. 3 illustrates a method of using the MCP mouse.

FIG. 4 illustrates an MCP fingertip tool according to a second embodiment of the present invention.

FIG. 5 illustrates a method of using the MCP fingertip.

FIGS. 6a and 6b illustrate an MCP key tool according to a third embodiment of the present invention.

FIG. 7 illustrates a method of using the MCP key tool.

FIG. 8 illustrates a general method of using an MCP tool.

FIG. 9 schematically illustrates various components of an overall system according to embodiments of the present invention.

FIG. 10 schematically shows a touch panel system in which embodiments of the present invention may be implemented.

### DETAILED DESCRIPTION OF THE PREFERRED EMBODIMENTS

As required, a detailed illustrative embodiment of the present invention is disclosed herein. However, techniques, systems, operating structures and methods in accordance with the present invention may be embodied in a wide variety of forms and modes, some of which may be quite different from those in the disclosed embodiment. Consequently, the specific structural and functional details disclosed herein are merely representative, yet in that regard, they are deemed to afford the best embodiment for purposes of disclosure and to provide a basis for the claims herein, which define the scope of the present invention. The following presents a detailed description of the preferred embodiment (as well as some alternative embodiments) of the present invention.

Embodiments of the present invention provide a way for a user to interact with a touch screen, in particular a large format touch screen, using mechanical objects (tools) that can contact the screen simultaneously at multiple contact points such that the touch points form pre-defined geometric patterns. The touch screen itself may be positioned vertically or horizontally. When the multiple contact points of the mechanical object contact the touch screen simultaneously, the touch screen system (controlled by appropriate hardware and software) detects the contact points and recognizes the pre-defined geometric patterns formed by the multiple contact points. The touch screen system defines a virtual device based on the geometric pattern, and generates appropriate input signals and responses. Thus, the mechanical object (tools) can perform the functions of a pointing device, much like the functions performed by a conventional pointing device such as a mouse for a conventional computer or a stylus/finger on a touch screen. As seen below, the tools can also perform functions not performed by conventional pointing devices. Further, the tools according to embodiments of the present invention can provide security features not available with conventional mouse of stylus.

For convenience, as used in this disclosure, an MCP (multiple contact point) tool is a physical object shaped to produce multiple simultaneous contacts with a touch screen, where the multiple contact points on the screen form a pre-defined geometric pattern due to the shape and construction of the physical object. The pre-defined geometric pattern has, for example, a pre-defined number of points, relative locations of the points, pre-defined distances among the points, etc. Some MCP tools have a fixed, unchangeable shape, while others may have mechanical structures that allow the geometric pattern of the contact points to be changed from one pre-defined pattern to another. A number of examples of MCP tools, including an MCP mouse, an MCP fingertip, and an MCP key tool, are described in more detail below.

The MCP tools described below interact with a touch panel system 1000 which is schematically shown in FIG. 10. The touch panel system 1000 includes a touch-sensitive screen 1002 (such as an LCD screen) which senses or detects touching of the screen by objects such as an MCP tool, a user's finger(s), etc. Any appropriate sensing technology may be used, including those used in conventional touch screen applications as well as those that may be developed in the future. Note that the touch sensitive screen 1002 may additionally perform the function of displaying information, similar to the case of a tablet computer and PDA, or it may not perform a display function, similar to the case of a touch pad of a laptop computer. The system 1000 also includes electrical circuitry and other suitable hardware, firmware and/or software (collectively, the control circuit 1004) which controls the touch screen 1002 and processes the detected touch data as appropriate. An external data processing device such as a computer 1006 may be connected to the touch screen 1002 and the control circuit 1004 to further processes data from the touch screen 1002. In a preferred embodiment where the external computer 1006 is provided, the touch screen control circuit 1004 may transmit raw input data, such as touch positions, to the computer 1006, and the computer processes the input data and generates appropriate responses.

More generally, the behavior of the system 1000 in response to the touch actions by the MCP tools, as will be described below, is controlled by software, firmware or hardware which may reside in the touch screen control circuit 1004, in the external device 1006, or in a combination of these components in a distributed manner. Hereinafter, the software, firmware or hardware that controls the behavior of the touch panel system 1000 is collectively referred to as the control section or control program for convenience.

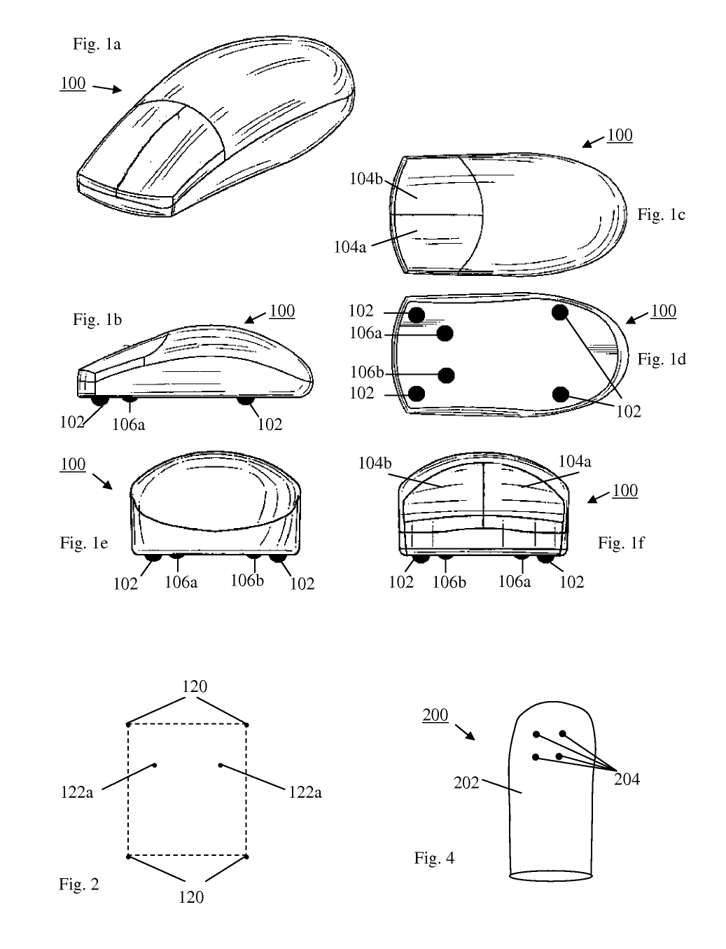

FIGS. 1a-1f illustrate an MCP mouse 100, which is an example of an MCP tool according to a first embodiment of the present invention. FIGS. 1a-1f are perspective, right, top, bottom, back and front side views of the MCP mouse 100, respectively. As seen in these figures, the MCP mouse 100 has the general exterior shape of a conventional mouse; however it does not have the mechanical or optical tracking mechanisms of a conventional mouse. The bottom side of the MCP mouse 100 is provided with a first group of protruding contact points 102, the lower ends of which are located on the same plane and form a two-dimensional geometric pattern. In this example, four contact points 102 form a rectangle with predetermined distances between the contact points. Other patterns, such as a triangle, a trapezoid, etc., can also be used.

In addition, the MCP mouse 100 has two buttons (press buttons) 104a, 104b located approximately at the positions of the left and right mouse buttons of a conventional mouse. The two press buttons 104a, 104b are mechanically coupled to two additional protruding contact points 106a, 106b, respectively. The additional contact points 106a, 106b protrude from the bottom side of the MCP mouse 100, but they protrude less than the first group of contact points 102 when the press buttons are not pressed. Thus, when the MCP mouse 100 is placed on the touch screen and the press buttons 104a, 104b are not pressed, the additional contact points 106a, 106b do not contact the screen. When the press buttons 104a or 104b is pressed, the additional contact points 106a or 106b protrudes more and its lower end can reach the same plane as the lower ends of the first group of contact points 102 to contact the screen. The two press buttons are normally biased toward the un-pressed position. The pressing buttons 104a, 104b and their coupling with the additional contact points 106a, 106b can be implemented by any suitable structure, preferably a mechanical structure.

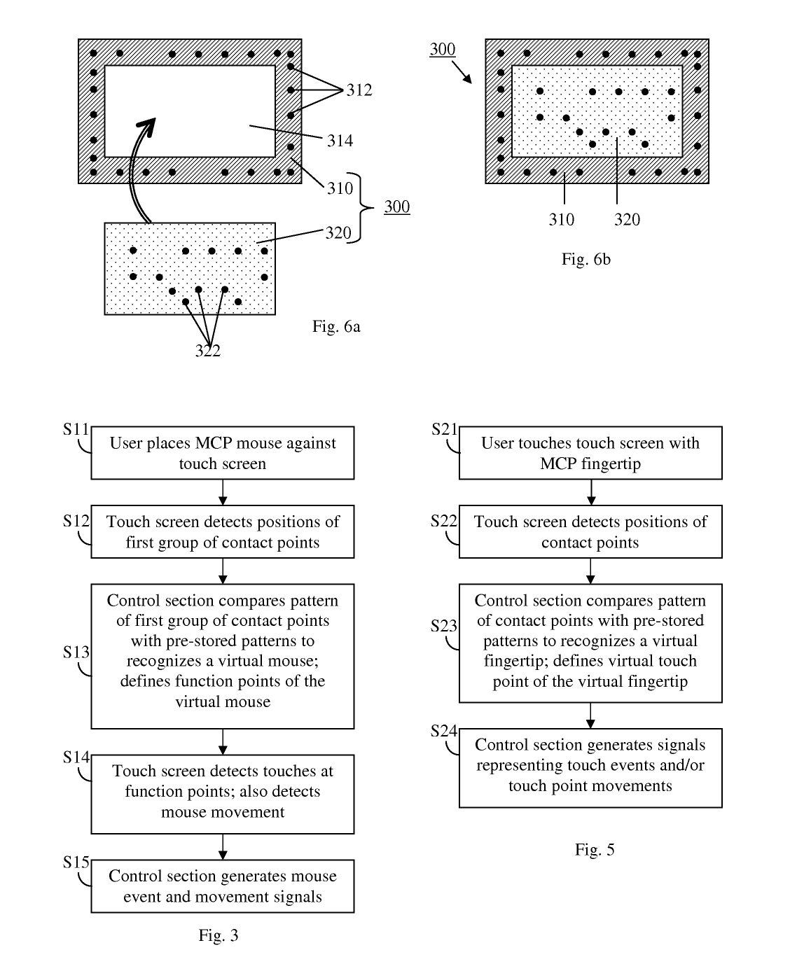

The use of the MCP mouse 100 is described with reference to FIG. 3. First, the user places the MCP mouse 100 against a touch screen 1002 with the first group of contact points 102 in contact with the screen but the additional contact points 106a, 106b not in contact with the screen (step S11). The user can freely move the MCP mouse and presses the press buttons 104a, 104b in similar ways a conventional mouse is used. The touch screen 1002 detects the positions of the first group of contact points 102 (step S12). FIG. 2 schematically illustrates the positions of the first group of contact points 120. The control section of the touch screen system 1000 compares the geometric pattern of the first group of contact points, including, for example, the number of points, their relative and/or absolute positions, the distances among them, etc., with pre-stored geometric patterns (step S13). The two patterns are considered to match each other if they are related to each other by a translation and/or a rotation. In this particular example, if the geometric pattern of the contact points 102 matches a pre-stored rectangular pattern, the control section determines that the device is an MCP mouse (i.e. the contact points are recognized as defining a virtual mouse) (step S13).

Based on this determination, the control section further defines the positions of a number of function points of the MCP mouse, along with the respective function associated with these function points (step S13). The positions of the function points are defined relative to the positions of the first group of contact points. In the illustrated embodiment, the control section defines two function points 122a and 122b as shown in FIG. 2, which correspond to the positions of the two additional contact points 106a, 106b of the MCP mouse 100. A touch at these function points may be defined as, for example, a mouse button (left or right button) down or up event. Thus, when the user presses a press button 104a or 104b of the MCP mouse 100, causing the corresponding additional contact point 106a or 106b to touch the screen, the touch screen detects the touch (step S14) and the control section generates appropriate mouse button events (step S15).

In addition, the control section defines a position of the MCP mouse, or a movement of the MCP mouse, based on the positions of the first group of contact points (step S14). For example, the position of one of these contact points 120 may be used as the position of the MCP mouse. Alternatively, a position having a pre-defined spatial relationship with the first group of contact points may be defined as the position of the MCP mouse. The mouse position and the button events may be further processed by the control section in ways similar to the processing of mouse positions and mouse button clicks in a conventional mouse (step S15). Collectively, the input events of the MCP mouse 100 allow the user to carry out operations similar to those offered by a traditional mouse or other mouse-type devices, such as pointing, clicking, dragging, drawing, etc.

In a preferred embodiment, the MCP mouse is used to control the position of a mouse cursor on a display screen, and to perform clicking and other functions in conjunction with the displayed cursor. In this preferred embodiment, even if the touch-sensitive screen also displays information, the MCP mouse does not directly interact with the displayed objects (icons, etc.) on the screen. In other words, the when the MCP mouse is placed on the touch screen, the displayed object at the physical location of the MCP mouse is not activated by the mouse; rather, the user uses the MCP mouse to control the displayed mouse cursor and interacts with the displayed objects via the displayed mouse cursor.

The control section of the touch panel system 1000 is programmed such that it will only react to simultaneous contacts of multiple contact points that form a geometric pattern matching one of the pre-stored patterns. For example, the control section can be programmed so that is does not react to a touch by one or two fingers. This effectively provides a security feature so that only users using an MCP tool having multiple contact points that match one of the pre-stored geometric patterns will be able to interact with the touch screen.

FIG. 4 illustrates another example of an MCP tool, referred to here as an MCP fingertip, according to a second embodiment of the present invention. In a preferred embodiment, the MCP fingertip 200 is in the form of a cover or sleeve 202 to be worn on a finger of a user. The cover 202 may be made of rubber, plastic or other suitable materials. The cover 202 may have an open or closed top end, and has an inner diameter of, for example, 1 cm to 2 cm. Disposed or formed on the tip of the cover are multiple contact points 204 forming a geometric pattern. In one example, four contact points 204 are disposed on the tip of the cover 202 forming a square having a size of, for example, 0.5 cm to 1 cm on each side.

In use (refer to FIG. 5), the user wears an MCP fingertip 200 on a finger and touches the touch screen 1002 so that the four contact points 204 contact the screen simultaneously (step S21). The touch screen senses the positions of the four contact points 204 (step S22), and the control section compares the sensed contact point positions with pre-stored geometric patterns (step S23). If the contact point positions are found to match a pre-stored pattern defining an MCP fingertip, the control section recognizes a virtual fingertip device and defines a virtual touch point based on the positions of the actual touch points (step S23). For example, the virtual touch point may be defined as the center of the square formed by the four actual touch points made by the four contact points 204. Based on the virtual touch point as well as the timing of the touches, the control section generates signals representing touch events or touch point movements (step S24). The control section can further process these touch events and touch point movements in a similar manner as in a conventional touch panel system (e.g. generating clicks, etc.).

In one implementation, the control section allows the MCP fingertip 200 to directly interact with displayed objects on the touch screen. For example, touching a displayed object using the MCP fingertip (i.e., when the virtual touch point is within the area of the displayed object) may cause the object to be selected, opened, and/or otherwise activated in a similar manner as a touch by a finger or stylus in a conventional touch screen application.

In an alternative implementation, the MCP fingertip 200 does not directly interact with the displayed object located under the contact points 204 or the virtual touch point. Rather, the positions and movements of the contact points 204 or the virtual touch point are recorded and used to control a displayed mouse cursor on a display screen. For example, a 1 cm movement of the MCP fingertip on the touch screen may cause the displayed mouse cursor to move 10 cm. A single or double brief touch by the MCP fingertip may be interpreted as a single or double click at the current position of the mouse cursor. Thus, the user interacts with the touch screen system by using the MCP fingertip to control the mouse cursor. This alternative embodiment may be especially useful when the display screen is a large format screen, such as a wall sized screen. Here, the display screen and the touch screen may be the same screen or different screens.

The control section can be programmed such that it does not react to a touch by the user's finger(s) without wearing the MCP fingertip tool. This effectively provides a security feature so that users not wearing an MCP fingertip tool will not be able to interact with the touch screen system.

FIGS. 6a and 6b illustrate an MCP key tool according to a third embodiment of the present invention. As shown in FIG. 6a (bottom plan view), the key tool 300 includes two parts: a key frame 310 and a key 320. The key frame 310 and the key 320 are two separate physical objects, where the key frame object has a hollow space 314 into which the key object can be inserted (see FIG. 6b). Preferably, the shape and size of the hollow space of the key frame object 310 matches the shape and size of the key object 320. The key frame object 310 has a number of contact points 312 disposed on its bottom surface forming a geometric pattern (a key frame code) in a plane. The key object 320 also has a number of contact points 322 disposed on its bottom surface forming a geometric pattern (a key code) in a plane. A number of key frame objects may be provided having different key frame codes; similarly, a number of key objects may be provided having different key codes. A key frame object and a key object combination may be used as a security tool to authenticate a user who has possession of these physical objects to a touch screen system.

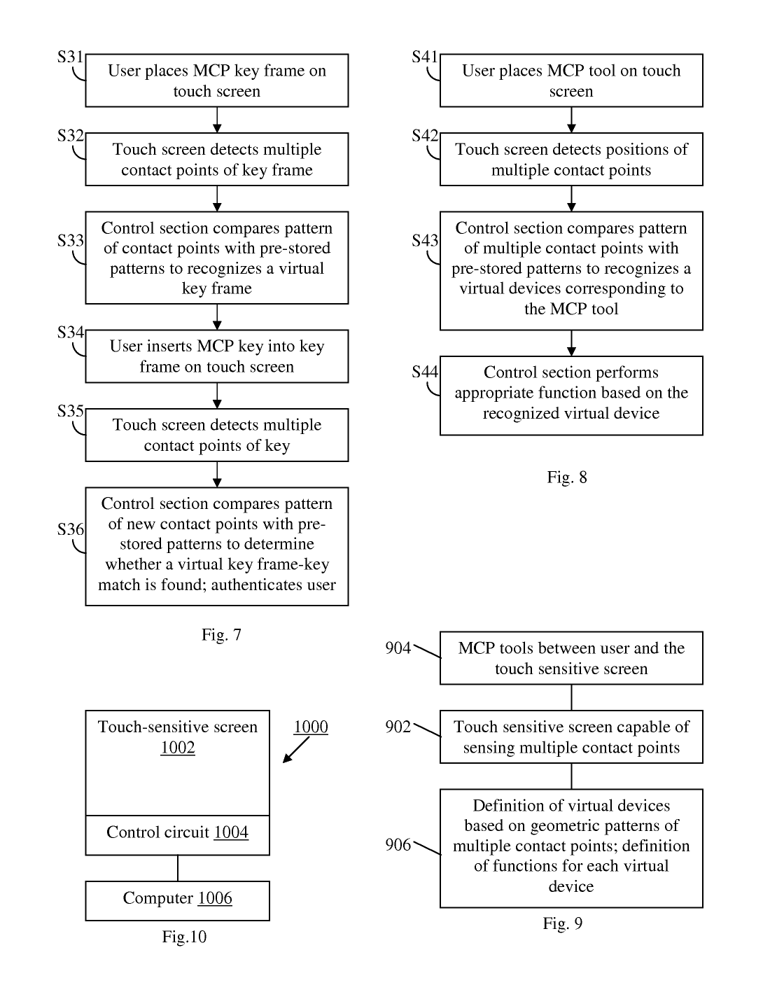

In use (refer to FIG. 7), the user first places the key frame object 310 on a touch screen so that the contact points 312 contact the screen. The touch screen detects the simultaneous touch of the multiple contact points 312 of the key frame object 310 (step S32). The control section compares the detected contact point positions with pre-stored geometric patterns. If the geometric pattern of the detected contact points matches a pre-stored pattern defining a key frame, the control section determines that the device is an MCP key frame (i.e. the matched contact points are recognized as defining a virtual key frame) (step S33).

The user then inserts the key object 320 into the hollow space 314 of the key frame 310 while the key frame is still touching the screen (step S34). The touch screen detects the simultaneous touch of the new contact points 322 of the key object 320 (step S35). The control section compares the geometric pattern of the new contact points 322 with pre-stored geometric patterns. If the geometric pattern of the new contact points 322 matches a pre-stored pattern defining an MCP key, the control section determines that a virtual key frame and virtual key match is found (step S36). In one embodiment, the algorithm requires that the position of the key pattern satisfies a pre-determined relationship relative to the position of the key frame pattern in order to find a match. For example, the algorithm may require that the key pattern be located in the space 314 defined by the key frame. If a key frame-key match is found, the control section authenticates the user, and the user is now allowed to interact with the touch screen system (step S36).

As mentioned before, multiple key frame objects and multiple key objects may be provided. The authentication system may be designed such that a key frame object can only be used with certain keys objects and vice versa. The control section may store information about the correspondence between virtual key frames and virtual keys. One virtual key frame may correspond to one or more virtual keys. Thus, in step S36, the algorithm determines whether the virtual key is one that corresponds to the already recognized virtual key frame in order to determine whether a match is found.

In an alternative embodiment, the user first inserts a key object 320 into the hollow space 314 of a key frame object 310, and then places the key frame object 310 along with the key object 320 on a touch screen so that the contact points contact the screen. The pattern matching algorithm will be more complex in such a case. While the detected contact points include both the set of contact points 312 and the set of contact points 322, the pattern matching step S33 will recognize a virtual key frame if some (but not necessarily all) contact points match a pre-stored pattern for a key frame. The pattern matching algorithm may be designed so that after a preliminary determination that a first set of contact points match a first pre-stored pattern for a key frame, the algorithm determines whether all remaining contact points (i.e. those not matching the first pattern) fall inside of a pre-defined center area corresponding to the key frame. If so, then the algorithm confirms that the first set of contact points define a virtual key frame. After the control section determines that a first set of contact points defined a virtual key frame, it compares the geometric pattern of the remaining contact points with pre-stored geometric patterns to determine whether the remaining contact points match a second pre-stored pattern defining a virtual key.

In the third embodiment, the MCP key tool does not interact with the objects (icons, etc.) displayed on the screen; it is only used to input authentication information into the system.

In steps S31 and S34 described above, the user first places the key frame object 310 without the key object 320 on the touch screen, and then inserts the key object into the hollow space 314 of the key frame object while keeping the key frame objects in contact with the touch screen. As an alternative, the key object is first partially inserted into the key frame object so that when the key frame object is places on the touch screen, only the contact points of the key frame object contacts the touch screen. Then, after the control section recognizes a virtual key frame, the user fully inserts the key objects into the key frame object so that the contact points of the key objects now contact the touch screen.

In one embodiment, the key frame objects and the key objects are objects having fixed shapes without moving parts. In another embodiment, the key object is made with moveable parts forming the contact points. For example, the contact points may be formed of a plurality of pegs slidably inserted into a plurality of holes on the key object. The user may insert the key object into to the key frame object but without fully sliding the pegs into the holes, place the key frame object on the touch screen, and then push the pegs fully down so that then contact the touch screen. In another example, the key object is provided with an array of holes into which pegs may be inserted. The user may insert (or fully insert) pegs into a selected subset of holes to forming a key code pattern.

While in FIGS. 6a and 6b the key frame is shown as having a rectangular hollow space 314 into the key object is inserted, the key frame object and the key object may have other shapes. For example, the hollow space 314 can have any shape. Further, the key frame object and the key object may have matching shapes that are designed to be placed next to each other (rather than the key object being inserted into the key frame object).

Three MCP tools and there use have been described in detail above. A more general description of a method of using an MCP tool is given with reference to FIG. 8. First, the user places an MCP tool on a touch screen (step S41). The MCP tool has a first group of contact points that contact the touch screen simultaneously when the tool is placed on the touch screen. The touch screen detects the positions of the multiple contact points (S42). The control section compares the geometric pattern of the multiple contact points with pre-stored geometric patterns to recognize a virtual device corresponding to the MCP tool (step S43). Using the above three embodiments, for example, if the multiple contact points match the pattern of an MCP mouse (see FIG. 2), the control section recognizes a virtual mouse; if the multiple contact points match the pattern of an MCP fingertip (see FIG. 4), the control section recognizes a virtual fingertip; and if the multiple contact points match the pattern of an MCP key frame (see FIGS. 6a, 6b), the control section recognizes a virtual key frame. Other virtual devices may be defined.

Then, based on the recognized virtual device, the control section performs functions appropriate for the virtual device (step S44). For example, if a virtual mouse is recognized, the control section defines two function points of the virtual mouse and responds to a touch at the function points appropriately. If a virtual fingertip is recognized, the control section defines a virtual touch point and responds to touch events by the virtual fingertip accordingly. If a virtual key frame is recognized, the control section analyzes additional contact points to detect a key code, and matches the key frame code and the key code to authenticate the user.

FIG. 9 schematically illustrates the various components of an overall system according to embodiments of the present invention. The first component 902 of the system is the touch sensitive screen (1002 of FIG. 10) which can physically sense multiple simultaneous contact points. This component may be a conventional touch sensitive screen. The second component 904 is a physical object (an MCP tool) having multiple contact points that is used on the touch screen. The third component 906 is the control section of the touch panel system 1000 (implemented in the control circuit 1004 and/or the computer 1006), which provides definition of various virtual devices corresponding to the various MCP tools based on geometric patterns of the multiple contact points, as well as definition of functions for each virtual device. The third component 906 operates to interpret the detected touch information from the first component 902.

It will be apparent to those skilled in the art that various modification and variations can be made in the touch screen system, the MCP tools and related method of the present invention without departing from the spirit or scope of the invention. Thus, it is intended that the present invention cover modifications and variations that come within the scope of the appended claims and their equivalents.

What is claimed is:

1. A touch screen system, comprising:
a touch screen for detecting simultaneous touches at a plurality of contact points on the touch screen, the plurality of contact points or a subset thereof forming a geometric pattern; and
a control section connected to the touch screen, the control section storing a plurality of pre-stored geometric patterns each corresponding to one of a plurality of virtual devices, the control section matches the geometric pattern formed by the plurality of contact points of the subset thereof with the pre-stored geometric patterns to recognize one of the plurality of virtual devices.

2. The touch screen system of claim 1, wherein the control section further performs one or more functions corresponding to the recognized virtual device.

3. The touch screen system of claim 2, further comprising a display screen, the display screen being the same as or different from the touch screen, wherein the one or more functions include one or more of: controlling a movement of a mouse cursor displayed on the display screen, activating an object displayed on the display screen, moving an object displayed on the display screen, and inputting authentication information.

4. The touch screen system of claim 1, wherein the plurality of virtual devices includes a virtual mouse, wherein in response to a virtual mouse being recognized, the control section defines one or more function points relative to the plurality of contact points and defines one or more functions each associated with one of the function points, and wherein in response to the touch screen detecting a touch at one of the function points, the control section performs the function associated with the function point.

5. The touch screen system of claim 4, wherein the one or more function points include a first function point and a second function point, and wherein the associated functions include a left mouse button event a right mouse button event.

6. The touch screen system of claim 4, wherein the control section further detects a movement of the virtual mouse based on a detected movement of one or more of the contact points and generates a mouse movement signal.

7. The touch screen system of claim 1, wherein the plurality of virtual devices includes a virtual fingertip, and wherein in response to a virtual fingertip being recognized, the control section defines a virtual touch point based on positions of the contact points.

8. The touch screen system of claim 7, wherein the control section generates signals representing a touch event or touch point movements based on positions and timing of the virtual touch point.

9. The touch screen system of claim 1, wherein the plurality of virtual devices includes a virtual key frame, and wherein in response to a virtual key frame being recognized, the control section determines whether a geometric pattern formed by a subset of the contact points matches a pre-stored geometric pattern defining a virtual key.

10. A mouse tool for use with a touch screen, comprising:
a body;
a first plurality of protruding contact points disposed on a bottom side of the body, the first plurality of contact points having lower ends disposed on a plane forming a geometric pattern;
a button mechanically coupled to the body; and
a moveable protruding contact point mechanically coupled to the button or disposed on a bottom side of the button, wherein when the button is pressed down, the moveable protruding contact point moves down and a lower end of the moveable protruding contact point reaches the plane formed by the lower ends of the first plurality of protruding contact points.

11. A fingertip tool for use with a touch screen, comprising:
a cover having an inner dimension of 1 cm to 2 cm; and
a plurality of contact points disposed near one end of the cover forming a geometric pattern.

12. A key tool for use with a touch screen, comprising:
a key frame object having a first plurality of protruding contact points disposed on a bottom side of the key frame object forming a first geometric pattern in a plane; and
a key object having a second plurality of protruding contact points located on a bottom side of the key object forming a second geometric pattern in a plane,
wherein the key frame object and the key object have matching shapes.

13. The key tool of claim 12, wherein the key frame object defines a hollow space having a shape that matches an outer shape of the key object.

14. The key tool of claim 12, wherein the key object has a plurality of holes and a plurality of pegs inserted into a selected subset of the holes.

15. A method of interacting with a touch screen system, the system including a touch screen and a control section connected to the touch screen, the method comprising:
placing a tool on the touch screen, wherein the tool has a plurality of contact points that simultaneously contact the touch screen, the plurality of contact points or a subset thereof forming a geometric pattern;
the touch screen detecting positions of the plurality of contact points;
the control section storing a plurality of pre-stored geometric patterns each corresponding to one of a plurality of virtual devices, and
the control section matching the geometric pattern formed by the plurality of contact points with the pre-stored geometric patterns to recognize one of the plurality of virtual devices.

16. The method of claim 15, further comprising:
the control section performing one or more functions corresponding to the recognized virtual device.

17. The method of claim 16, wherein the touch screen system further includes a display screen connected to the control section, the display screen being the same as or different from the touch screen, wherein the one or more functions include one or more of: controlling a movement of a mouse cursor displayed on the display screen, activating an object displayed on the display screen, moving an object displayed on the display screen, and inputting authentication information.

18. The method of claim 15, wherein the plurality of virtual devices includes a virtual mouse, the method further comprising:
in response to a virtual mouse being recognized, the control section defining one or more function points relative to the plurality of contact points and defining one or more functions each associated with one of the function points;
the touch screen detecting a touch at one of the function points;
in response to the touch screen detecting the touch at the function points, the control section performing the function associated with the function point; and
the control section detecting a movement of the virtual mouse based on a detected movement of one or more of the contact points and generating a mouse movement signal.

19. The method of claim 15, wherein the plurality of virtual devices includes a virtual fingertip, the method further comprising:
in response to a virtual fingertip being recognized, the control section defining a virtual touch point based on positions of the contact points and generating signals representing a touch event or touch point movements based on positions and timing of the virtual touch point.

20. The method of claim 15, wherein the plurality of virtual devices includes a virtual key frame, the method further comprising:
in response to a virtual key frame being recognized, the control section determining whether a geometric pattern formed by a subset of the contact points matches a pre-stored geometric pattern defining a virtual key.
